(19) United States
(12) Patent Application Publication
(10) Pub. No.: US 2010/0281123 A1
(43) Pub. Date: Nov. 4, 2010

(54) SYSTEM AND METHOD FOR TARGETED COMMUNICATION

(76) Inventor: CHARLES GREENBERG, WEED, NM (US)

Correspondence Address: THE ADAMS KENNEDY LAW FIRM, LLC, 901 RIO GRANDE BLVD. NW, SUITE H262, ALBUQUERQUE, NM, 87111, US

(21) Appl. No.: 12/773,506

(22) Filed: May 4, 2010

Related U.S. Application Data
(60) Provisional application No. 61/175,373, filed on May 4, 2009.

(51) Int. Cl. G06F 15/16; H04W 4/14

(52) U.S. Cl. 709/206; 455/466

(57) ABSTRACT

Aspects of the present invention can include a method for targeted communication of a message to one or more users. The example method described herein can include the steps of in response to a first input, selecting a predetermined message and in response to a second input, selecting a predetermined user group to receive the predetermined message. Further steps of the example method can include in response to a third input, selecting a predetermined time for transmission of the predetermined message to the predetermined user group; and transmitting the predetermined message to the predetermined user group in response to the predetermined time. Other aspects of the present invention can be configured as computer program products and systems and/or devices adapted to perform one or more steps of the example methods.

### CLAIM OF PRIORITY

The present invention claims priority to U.S. provisional patent application Ser. No. number 61/175,373 filed on May 4, 2009 and entitled “System and Method for Targeted Communication,” which is incorporated by reference herein in its entirety.

### BACKGROUND AND SUMMARY

1. Technical Field

The present invention relates generally to the field of communications, and more particularly to the field of networked communications utilizing one or more voice and/or data transmission protocols.

2. Summary of the Present Invention

The continuing proliferation of mobile communications devices permits near constant and instant communication between individuals on a nearly worldwide basis. With the ascent of communications technology, there has also been an increase in the need for standardized and targeted communications within certain demographic groups, particularly in emergency situations. For example, the United States has been home to numerous high profile and unfortunately violent outbursts at several schools in the past decade. As always in the case of emergency, consistent and clear communications are necessary to ensure the safety of the individuals as well as their loved ones. The problem can be even more exacerbated in instances where the affected group is not able to utilize communications on their own accord, for example in an elementary or middle school. Similar communications issues have arisen in cases of natural disaster, such as in the case of wildfires or hurricanes that are an annual occurrence in the United States.

One embodiment of the present invention includes a method including in response to a first input, selecting a predetermined message and in response to a second input, selecting a predetermined user group to receive the predetermined message. The method of the first embodiment can also include in response to a third input, selecting a predetermined time for transmission of the predetermined message to the predetermined user group; and transmitting the predetermined message to the predetermined user group in response to the predetermined time.

A second embodiment of the present invention includes a computer program product having a computer readable storage medium having computer readable program code embodied therewith. The computer readable program code of the second embodiment can include computer readable program code to select a predetermined message in response to a first input and computer readable program code to select a predetermined user group to which the predetermined message is to be transmitted. The computer readable program code of the second embodiment can also include computer readable program code to select a predetermined time for transmission of the predetermined message to the predetermined user group and computer readable program code to transmit the predetermined message to the predetermined user group at the predetermined time.

A third embodiment of the present invention includes a system including a communication device. The communications device of the third embodiment can further include a messaging center having a message module adapted to compile one or more predetermined messages, a list module adapted to compile one or more predetermined user groups, and a schedule module adapted to correlate a transmission of the one or more predetermined messages to one or more predetermined user groups at a predetermined time. The communications device of the third embodiment can also include a user interface adapted to permit an administrator to select from the one or more predetermined messages, the one or more predetermined user groups and the predetermined time.

These and other features and advantages of the present invention are described in detail herein with reference to the following figures.

### BRIEF DESCRIPTION OF THE DRAWINGS

FIG. 1 is a schematic block diagram of a system for targeted communication in accordance with a preferred embodiment of the present invention.

FIG. 2 is an example screenshot of a user terminal usable in the systems and/or methods of the preferred embodiments of the present invention.

FIG. 3 is a flowchart depicting a method for targeted communication in accordance with a preferred embodiment of the present invention.

FIG. 4 is a schematic block diagram of a system for targeted communication in accordance with the preferred embodiment of the present invention.

### DESCRIPTION OF THE PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof, and may be transitory or non-transitory in nature. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language or similar programming languages. The programming code may execute entirely on the user's computer, partly on the user's computer, as a stand-alone software package, partly on the user's computer and partly on a remote computer or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in he flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a special purpose computer such as a server, or a smart phone, soft phone, personal digital assistant or any other machine adapted for executing programmable instructions in accordance with the description thereof set forth above.

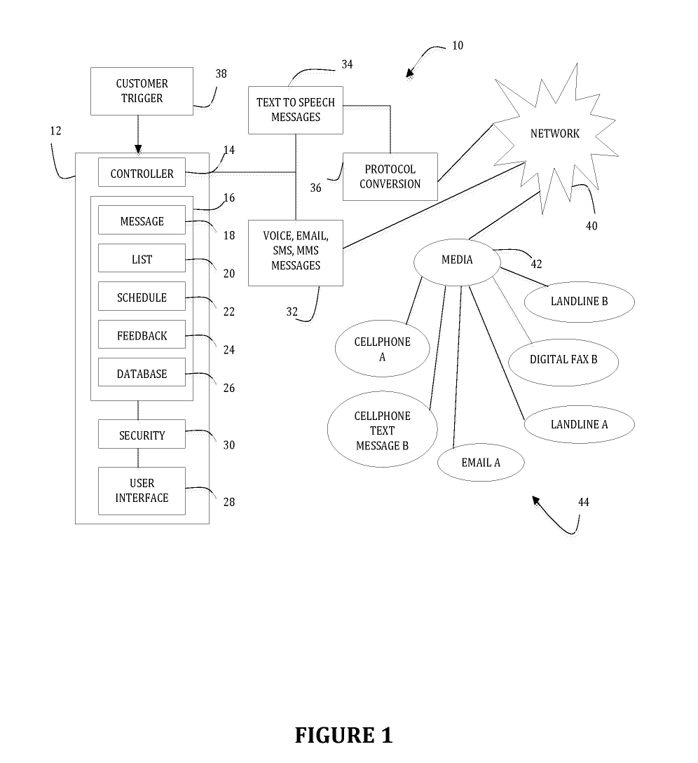

As shown in FIG. 1, a communication system 10 of the preferred embodiment includes a communications device 12 that is connectable to a network 40 for communicating to one or more users 44 through a one or more selected media 42. In particular, the communications device 12 can include a stand-alone module or device that is networked with other modules (not shown) that are capable of wired and/or wireless communications according to one or more known communications protocols and/or specifications, including at least PSTN, VoIP, TDM, TDMA, CDMA, GSM, WCDMA, WiFi, and the like. The communications device 12 can be configured as a single terminal, or as one or more terminals networked to one another directly or through a server. The communications device 12 functions to store, select, integrate, compile and transmit selected messages to a predetermined user group selected from the one or more users 44. The one or more users 44 can be divided into one or more user groups, for example user group A and user group B as shown in FIG. 1.

In one variation of the system 10 of the preferred embodiment, the communications device 12 can include a controller 14, such as a general processor, computer, or other combination of hardware, firmware or software that is adapted to execute machine readable instructions to enable the functions of the communications device 12. The controller 14 can be connected to a message center 16, which can be a combination of hardware, firmware or software with integrated functions. The message center 16 can be integrated into a single device, or disintegrated into multiple networked or otherwise communicable devices as described further herein. For example, the message center 16 can include a message module 18, a list module 20, a schedule module 22, a feedback module 24 and a database 26. The message module 18 can include one or more messages formatted in various media having standardized or customized content. Alternatively, an administrator can utilize a user interface 28 for creating and/or modifying existing message content in the message module 18 according to automated or user-defined specifications.

The list module 20 can include a combination of hardware, firmware or software for creating, modifying or maintaining one or more lists of user groups selected from the one or more users 44. The list module 20 functions to generate and/or maintain the lists of user groups thereby enabling rapid and consistent communication of the message(s) to the selected user group. The user groups can be determined according to any preferences determined by an administrator, such as for example demographic groups of parents having children in a particular school, or parents having students in a particular grade, class, homeroom and the like. The lists of the list module 20 can be categorized according to the media 42 in which the message is to be transmitted, i.e. email addresses, mobile phone numbers, fax numbers, residential telephone numbers and the like. Accordingly, an administrator can have multiple lists for each user group according to the selected media 42. Alternatively, the list module 20 can be adapted to group all contact information for each type of media according to the user group, thereby enabling communication of a message to the user group through two or more types of media, such as transmission of the message to the user group via email, voicemail, text-to-speech, fax and/or text (SMS or MMS) message at substantially the same time.

The message center 16 can also include a scheduling module 22 that functions to allow an administrator to select the time at which the message is delivered to the one or more user groups. The scheduling module 22 can be adapted to schedule the transmission of the message at predetermined times or in response to administrator input. For example, in the case of an emergency, the administrator can authorize the scheduling module 22 to schedule the transmission of the message(s) instantaneously to the selected user groups. Alternatively, the scheduling module 22 can be configured to automatically schedule the transmission of selected types of messages in response to predetermined inputs. For example, in the event of a school closing or delay due to weather, the scheduling module 22 can be adapted to always transmit the message conveying such information at a predetermined time, such as before the school is open or the buses begin their runs.

The message center 16 can also include a feedback module 24 for receiving feedback from one or more members of a user group. The feedback 24 module can include any suitable combination of hardware, firmware or software adapted to receive messages from the one or more members of the user group in any suitable media, including at least email, voicemail, text-to-speech, fax and/or text (SMS or MMS) messages. The feedback can include a confirmation of receipt of a message, particularly if the message is an emergency message. Thus for example if an emergency message is directed to parents of a group of schoolchildren, then the receiving parents can confirm receipt of the message thereby acknowledging the particular situation. Feedback messages can be directed at least in part to a database 26, which can be configured for automatically updating a status of one or more user groups, messages, lists, and schedules. The database 26 can include sufficient memory and storage for partitioning data among message types, user groups, schedules, lists, and feedback as well as other database configurations desired by the administrator.

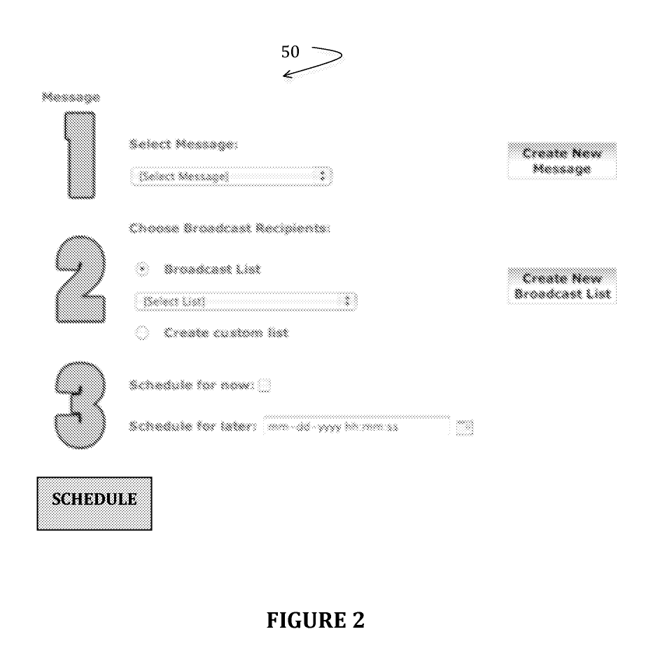

As noted above, the communication device 12 can also include a user interface 28 adapted to allow the administrator to customize, create and/or modify any module in the message center 16, including at least messages, lists, user groups, schedules, and feedback parameters. The user interface 28 can include for example a display and input means, such as a keyboard, microphone, TDD/TTY inputs and the like for interacting with the message center 16. One example user interface 28 is shown in FIG. 2, which depicts a screen shot of a display 50 outlining a process through which the administrator can select a message, select a user group and select a schedule for transmitting the message. The communication device 12 can also include one or more security protocols 30 operating between the user interface 28 and the message center 16 for ensuring the privacy of any user data stored on the database 26.

In another variation of the system 10 of the preferred embodiment, messages can be created and delivered by the message center 16 in response to a customer trigger 38. A customer trigger 38 can include any automatically determined user status. For example, in a commercial setting, a customer trigger 38 can include a past due notice for a payment, in which case the creditor can employ the system 10 of the preferred embodiment to automatically send one or more messages to a user that has a past due payment. The use of the customer trigger 38 feature(s) can streamline the use of the system 10 of the preferred embodiment by reducing the need for manual operation of the message center 16. The customer trigger 38 can include specified fields that correspond to predetermined messages, scheduling, user groups, and feedback, such that upon receipt of the customer trigger 38, the controller 14 controls the message center 16 to direct one or more messages to the selected recipients.

The communication device 12 is connectable to a network 40 through either wired or wireless means, including but not limited to: Ethernet, VoIP, digital or analog TDM, cellular voice and data protocols, WiFi wireless protocols and any other suitable networking system. As shown in FIG. 1, messages can be of numerous types depending upon the user group and the selected media 42. As an example, some messages can be formatted as voice, email or SMS messages 32, and other messages can be formatted as text to speech messages 34 in which a textual message is converted to a spoken message via a protocol conversion 36 prior to delivery through the network 40. Messages determined at the message center 16 can be formatted in multiple media 42 for delivery to one or more devices used by the same user. For example, a single message can be delivered to a single user's smartphone via voicemail, email, SMS and a text to speech converted message. In this manner, the system 10 of the preferred embodiment can create and deliver redundant messages to a user, thereby increasing the possibility that the user will receive the message.

The network 40 can include an Internet or intranet network, a cellular voice and/or data network, a PSTN or a satellite voice and/or data network, as well as any combination or subcombination thereof. The network 40 can include one or more subnets adapted to communicate different types of messages, such as email, voicemail, fax and/or text (SMS or MMS) message. As such, the network 40 can be adapted to communicate in various media, including the aforementioned message types, and receive and transmit any feedback from the one or more users 44 to the communications device 12.

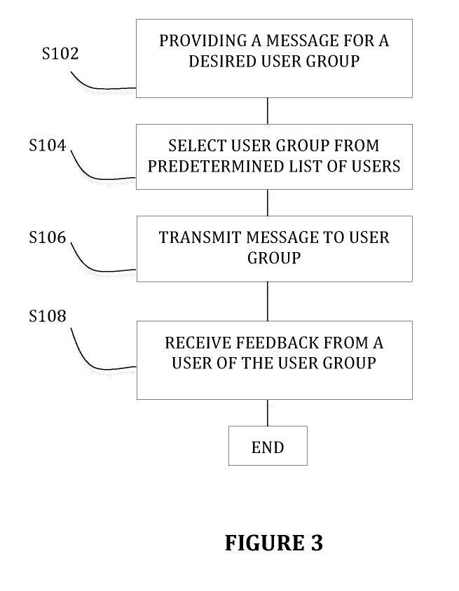

The present invention also includes a method of communicating with one or more targeted users in a user group. As shown in FIG. 3, the method of the preferred embodiment includes step S102, which recites providing a message for a desired user group. As noted above, the message can be created, modified, and/or customized by the administrator prior to sending. The message can be formatted in any number of various formats or media, including email, voicemail, fax and/or text (SMS or MMS) message. Step S104 of the method of the preferred embodiment recites selecting a user group from a predetermined list of users. The user group can conform to any predetermined specifications set forth by the administrator to ensure that members of selected group receive the desired messages, and other users do not accidentally or inadvertently receive messages. Step S106 of the method of the preferred embodiment recites transmitting the message to the user group. As noted above, the message can be transmitted by a network through any suitable communication means, including at least wired, wireless and satellite networking protocols. Step S108 of the method of the preferred embodiment recites receiving feedback from a user of the user group. The feedback can be used by the system 10 of the preferred embodiment to ensure message delivery and receipt, as well as to update the database 26 to avoid resending an identical or similar message to the user submitting the feedback.

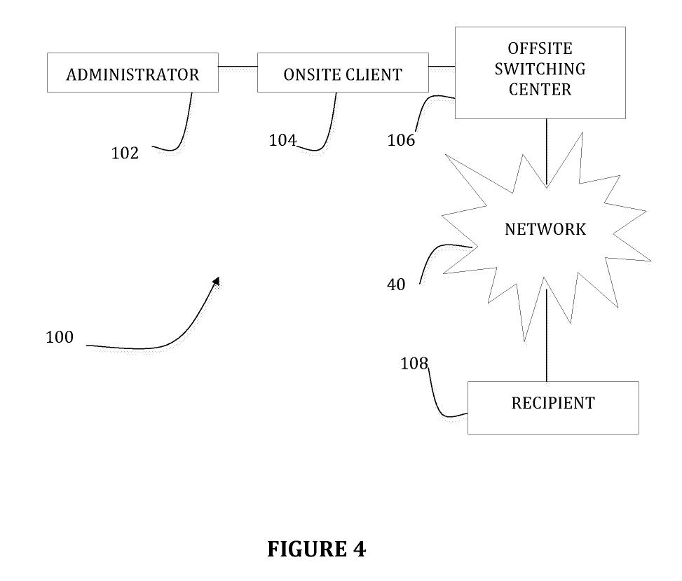

As shown in FIG. 4, a system 100 of another preferred embodiment can include an administrator terminal 102 connected to an onsite client 104. The administrator terminal 102 functions to permit an administrator to select one or more recipients 108 of a message of the type described herein. The onsite client 104 functions to receive inputs from the administrator terminal 102 regarding for example a selected message, a selected message type and a message schedule and transmit such information to an offsite switching center 106. The offsite switching center 106 communicates the predetermined message(s) at the predetermined time(s) to one or more recipients 108 via a network 40 of the type described above. Unlike the system 10 of the preferred embodiment described above with reference to FIG. 1, the system 100 of the preferred embodiment disintegrates the functions of the communications device 12 and separates them into the onsite client 104 and the offsite switching center 106. In this manner, the recipient information remains onsite with the administrator at the onsite client 104 while the primary messaging functions including distribution, feedback receipt and the like are performed at the offsite switching center 106.

In one variation of the system 100 of the preferred embodiment, the administrator terminal 102 can be connected to the onsite client 104 via a wired or wireless Intranet. Alternatively, the administrator terminal 102 can be integrated with the onsite client 104 insofar as the onsite client 104 includes recipient information, the database configuration and the like. Upon receipt of a message request from the user, the onsite client 104 communicates predetermined aspects of the message such as those set forth in FIG. 1 to the offsite switching center 106. Communications between the onsite client 104 and the offsite switching center 106 can be accomplished via a secure virtual private network, such as for example REST. The offsite switching center 106 can then perform the remaining functions allocated to the communications device 12 of the system 10 of the preferred embodiment. It should be apparent to those of skill in the art that the switching center 106 can be configured for communication with more than one onsite client 104 for multiple administrators, each of which can have multiple groups of recipients. Disintegration of the messaging functions from the administrator-implemented functions as described above permits an administrator to more easily enjoy the benefits described herein without having to adopt the fully integrated system 10 of the preferred embodiment described herein.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements and specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical applications, and to enable others of ordinary skill in the art to understand the invention for various embodiments with various modifications as are suited to the particular use contemplated.

What is claimed is:

1. A method comprising:
in response to a first input, selecting a predetermined message;
in response to a second input, selecting a predetermined user group to receive the predetermined message;
in response to a third input, selecting a predetermined time for transmission of the predetermined message to the predetermined user group; and
transmitting the predetermined message to the predetermined user group in response to the predetermined time.

2. The method of claim 1, further comprising the step of receiving feedback from a user of the predetermined user group confirming receipt of the predetermined message.

3. The method of claim 1, wherein the predetermined message is transmitted to the predetermined user group through one or more media.

4. The method of claim 3, wherein the predetermined message is transmitted to the predetermined user group substantially simultaneously through two or more media.

5. The method of claim 3, wherein the one or more media comprises a voice medium, a text medium, an SMS medium or an MMS medium.

6. The method of claim 1, further comprising the step of receiving, from each user in the predetermined user group, a contact list comprising communication protocols and contact information for one or more receivers.

7. The method of claim 6, wherein the step of transmitting the predetermined message comprises, for each user in the predetermined user group, transmitting the predetermined message to two or more receivers.

8. The method of claim 6, wherein the one or more receivers comprises one or more of a mobile telephone, smart telephone, personal digital assistant, personal computer terminal, electronic mail server, landline telephone or digital facsimile machine.

9. The method of claim 7, wherein the step of transmitting the predetermined message to the two or more receivers further comprises substantially simultaneously transmitting the predetermined message to two or more receivers.

10. A computer program product comprising:
a computer readable storage medium having computer readable program code embodied therewith, the computer readable program code comprising:
computer readable program code to select a predetermined message in response to a first input;
computer readable program code to select a predetermined user group to which the predetermined message is to be transmitted;
computer readable program code to select a predetermined time for transmission of the predetermined message to the predetermined user group; and
computer readable program code to transmit the predetermined message to the predetermined user group at the predetermined time.

11. The computer program product of claim 10, further comprising computer readable program code to receive feedback from a user of the predetermined user group confirming receipt of the predetermined message.

12. The computer program product of claim 10, wherein the predetermined message is transmitted to the predetermined user group through one or more media.

13. The computer program product of claim 12, wherein the predetermined message is transmitted to the predetermined user group substantially simultaneously through two or more media.

14. The computer program product of claim 12, wherein the one or more media comprises a voice medium, a text medium, an SMS medium or an MMS medium.

15. The computer program product of claim 10, further comprising computer readable program code to receive, from each user in the predetermined user group, a contact list comprising communication protocols and contact information for one or more receivers.

16. The computer program product of claim 15, wherein computer readable program code to transmit the predetermined message comprises, for each user in the predetermined user group, computer readable program code to transmit the predetermined message to two or more receivers.

17. The computer program product of claim 15, wherein the one or more receivers comprises one or more of a mobile telephone, smart telephone, personal digital assistant, personal computer terminal, electronic mail server, landline telephone or digital facsimile machine.

18. The computer program product of claim 16, wherein the computer readable program code to transmit the predetermined message to the two or more receivers comprises computer readable program code to substantially simultaneously transmit the predetermined message to the two or more receivers.

19. A system comprising:
a communication device comprising:
a messaging center comprising a message module adapted to compile one or more predetermined messages, a list module adapted to compile one or more predetermined user groups, and a schedule module adapted to correlate a transmission of the one or more predetermined messages to one or more predetermined user groups at a predetermined time; and
a user interface adapted to permit an administrator to select from the one or more predetermined messages, the one or more predetermined user groups and the predetermined time.

20. The system of claim 20, further comprising: a feedback module adapted to receive a message from one or more users of the one or more user groups and a database adapted to update in response to feedback from one or more users of the one or more user groups.
